(19) United States
(12) Patent Application Publication
(10) Pub. No.: US 2004/0261111 A1
(43) Pub. Date: Dec. 23, 2004

(54) Interactive mulitmedia communications at low bit rates

(76) Inventors: Abulgasem Hassan Aboulgasem, Santa Clara, CA (US); Nadeemul Haq, San Jose, CA (US)

Correspondence Address: DAVID GIGLIO, ESQ., 231 ELIZABETH St., UTICA, NY, 13501, US

(21) Appl. No.: 10/872,841

(22) Filed: Jun. 21, 2004

Related U.S. Application Data
(60) Provisional application No. 60/481,004, filed on Jun. 20, 2003.

(51) Int. Cl. H04N 7/173; H04B 1/66; H04N 7/12; H04N 11/02; H04N 11/04

(52) U.S. Cl. 725/86; 725/120

(57) ABSTRACT

An apparatus and method for providing two way video communications includes a source and destination at each location. The destination includes dual display buffers, dual I-frame buffers, a motion vectors buffer and a backup display buffer. A first I-frame is transmitted from a source to a destination via a plurality of fragmented sub-frames. The sub-frames comprising the first I frame are received in a first frame buffer. Corresponding motion vectors and associated prediction error are received in the motion vectors buffer. Once each of the sub-frames of the first I-frame have been received in the first I frame buffer, they are inversely coded into the first display buffer. At predetermined time intervals a motion vector is applied to the inversely coded I-frame to display the applied I-frame stored in the first display buffer. Each of the motion vectors stored in the motion vectors is sequentially applied to the first I-frame. After each of the motion vectors has been applied the motion vector buffer is flushed. A second I-frame is transmitted from the source to the destination and received in a second I-frame buffer in much the same way as the first I-frame had been transmitted. Once each of these second I-frame sub-frames have been received in the second I-frame buffer, they are also inversely coded into a second display buffer. A second set of motion vectors corresponding to the second I-frame is transmitted from the source and received in the motion vectors buffer. This second I-frame is now displayed at predetermined time intervals using the corresponding second set of motion vectors.

The disclosure of this patent document contains material to which the claim of copyright protection is made. The copyright owner has no objection to the facsimile reproduction by any person of the patent document or the patent disclosure, as it appears in the U.S. Patent and Trademark Office patent file or records, but reserves all other rights whatsoever. This patent application claims priority from provisional patent application 60/481,004 filed on Jun. 20, 2003 by the same inventors which is incorporated herein by reference.

### FIELD OF THE INVENTION

The present invention relates generally to two-way interactive video communication. It is an algorithm that allows rendering of video frames at the remote terminal with low effective transmission delay, at a fixed frame rate, when encoded natural video is transmitted over the network at low bit-rates and variable transmission delay.

### BACKGROUND OF THE INVENTION

Prior art exploits temporal and spatial redundancy in natural video frame sequences to achieve high degree of compression and consequently optimal use of transmission bandwidth. A transmitted video sequence is encoded as a series of packetized reference frames interspersed with motion vectors and associated error packets at the source. The receiver uses the intra-coded images (I-frames) as reference frames and generates two types of dependent frames: predictive coded frames (P-frames) and bi-directionally coded frames (B-frames).

P frames are coded predictively from the closest previous I-frame; B-frames are coded bi-directionally from the preceding and succeeding I-frame and/or P-frame. Dependent frames are coded by performing motion estimation. Several methods of motion estimation are known:

(a) Block matching

(b) Gradient method

(c) Phase correlation

Prior art frame compression and regeneration methods are generally applicable to streaming video but are not applicable to two-way interactive multi-media communication at low bit-rates because of the following:

(1) Interactive communication requires a generally accepted round trip delay of audio/video frames that does not exceed 250 milli-second and a one-way delay that does not exceed 150 milli-second.

(2) The significant sources that contribute to the video frame transmission delay are:

(a) Serial link delay from CCD camera to the encoder at source

(b) Encoder compute delay

(c) Transmission time of the video frame from source to destination at low bit rate

(d) Decoder (frame regeneration) delay at destination

(e) Rendering delay

(1) The estimate of various delays between local and remote terminals is as follows:

(a) Serial link delay (C) from the CCD camera to the encoder is dependent on the link type; the delay range is expected between 5.0 milli-seconds (USB 2.0) and 200 milli-seconds (USB 1.0).

(b) The encoder delay (E) is highly implementation dependent. Hardware solutions with high degree of parallelism could take approximately 50 milli-seconds to encode a CIF resolution frame.

(c) At a compression ratio of 50:1 with minimum guaranteed access bandwidth of 128 kbps the total maximum encoded I-frame transmission time (T) is 250 milli-seconds. It should be noted that both compression ratio and available bandwidth are variables and hence the encoded I-frame transmission time is an approximation.

(d) Source to destination propagation delay is highly dependent on the level of congestion encountered along the path taken by the packets. Generally accepted worst-case one-way network propagation delay (P) for interactive communication is 150 milli-seconds but this limit could be breached by real traffic. Occasional packets that are delayed beyond this limit may be dropped along the way or at the destination.

(e) Frame regeneration delay (D) is highly implementation dependent. Highly parallel hardware solutions could take approximately 10 milli-seconds to regenerate a frame.

(f) The rendering delay (R) is different for each pixel. At a refresh rate of 60 Hz it linearly increases from 0 to 16 milli-second from first to last pixel.

(1) Barring any overlap in processing, cumulative delay experienced by the video frames from source to destination is approximated at:

C+E+T+P+D+R ˜676 ms

This is well beyond the acceptable delay for interactive video and associated audio for multi-media communication. It should be noted that audio part of the multi-media does not experience the same delays as the video. Delays associated with C, E, T, D or R do not impact audio. The audio undergoes nominal delays associated with the audio encoder and decoder and the propagation delay through the network.

(2) The prior art constraints do not impact streaming video since round trip delay constraint does not exist; buffering of video and audio streams at source and destination removes any artifacts introduced by variation in propagation delay.

(3) Prior art eliminates the effect of variable transmission delay by frame buffering at destination. This solution adds to the effective transmission delay and is therefore not viable for two-way interactive communication.

### SUMMARY OF THE INVENTION

There is provided a system and apparatus of an affordable multi-media communication over existing public infrastructure. Since existing public infrastructure supports typically low bit-rates at WAN accesses, it is imperative for good quality two-way multi-media communication to have a method to compensate for delays and variations in delay incurred during compression, propagation, de-compression and rendering of video frames.

### BRIEF DESCRIPTION OF DRAWINGS

The above and other objects of the present invention will be better understood by reading the following detailed description of the preferred embodiments of the invention, when considered in connection with the accompanying drawings, in which:

FIG. 1 shows a block diagram in accordance with a preferred embodiment of the present invention.

### DESCRIPTION OF INVENTION

The algorithm is intended for two-way communication therefore at-least two sources and two destinations are involved; however, since the setup is similar at both ends, description of algorithm from a source to a destination would suffice.

The algorithm assumes use of similar or compatible equipment at both source and destination.

Since packet delays and delay variation through the network are not known and cannot be predicted accurately at the source, the algorithm is largely implemented at the destination.

Because of round-trip delay constraint on two-way communication, algorithms based on closed loop feedback are not viable.

At the Source:

Raw picture frames are received from the camera. Raw picture frames (RGB) are Gamma corrected and quantized/compressed to generate quantized frames.

A quantized/compressed frame (I-frame) is segmented into multiple sub-frames.

The sub-frames are packetized. The maximum size of sub-frames is determined by the available bit rate such that transmission of a complete sub-frame packet is possible over the network during Tf. ‘Tf’ is a measure of time that is based on frequency of audio packets.

The sub-frame comprises:

(1) A sequence number field that is used to:

(a) Help reconstruct the original I-frame at the destination

(b) Allow compensation for sub-frame packets that may be lost or delayed excessively in the network

(2) Corresponding I-frame segment

Motion vectors and associated errors are generated for all subsequent quantized frames received from the camera until all sub-frame packets of the first I-frame have been transmitted.

The motion vectors are packetized.

A motion vector packet is transmitted (every Tf) between successive sub-frame packets. The motion vector packets therefore effectively cut through sub-frames of the first I-frame completely transmitted.

Once all sub-frames of the first I-frame have been transmitted another I-frame is segmented into sub-frames. The sub-frames are packetized and transmission cycle is repeated.

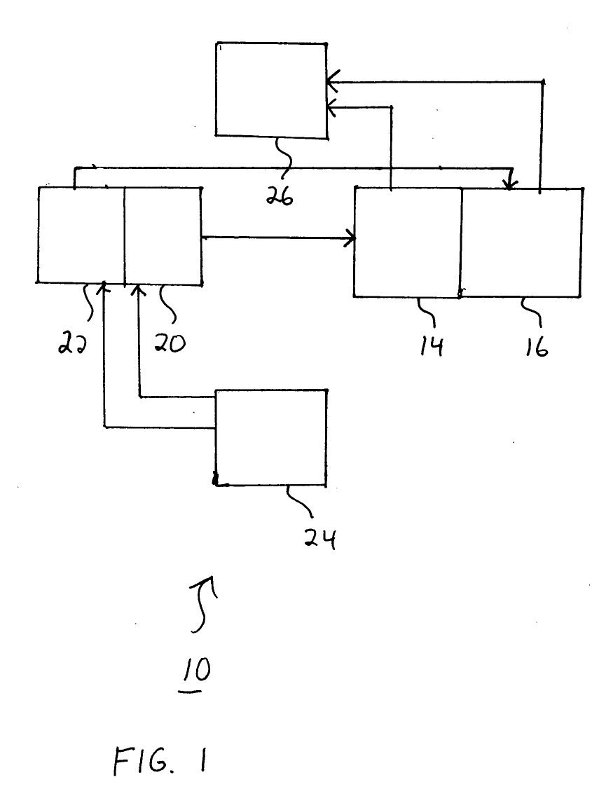

Referring now to FIG. 1 and at the destination 10, there is provided a dual display buffer Dbuf0 14 and Dbuf1 16, dual I-frame buffers Ibuf0 20 and Ibuf1 22, a motion vectors buffer 24 and a backup display buffer 26.

Since each sub-frame is a fixed size the location of the sub-frame within the I-frame buffer is known. As sub-frames of the first I-frame are received they are stored in Ibuf1 22 in their corresponding location.

As motion vectors and associated prediction errors are received they are stored in the motion vector buffer 24.

A timer triggers update of the display buffer Dbuf0 14 every Tf period and the next available motion vector and associated prediction errors are applied to it.

This process continues till all sub-frames of the first I-frame have been received in Ibuf1 22.

At this time contents of the Ibuf1 22 are inverse-coded into Dbuf1 16 and motion vectors stored in the motion vector buffer 24 and their associated prediction errors are applied sequentially to I-frame stored in Ibuf1 22.

A copy of Dbuf1 16 is saved in the backup display buffer 26. Contents of the backup display buffer 26 when coded are used to substitute missing or corrupted sub-frames of the incoming I-frame.

After all motion vectors stored in the motion vector buffer 24 have been applied to the contents of Ibuf1 22 the following happens:

(a) Dbuf1 16 becomes the current display buffer

(b) Motion vector buffer 24 is flushed

As sub-frames of the second I-frame are received they are stored in Ibuf0 20 in their corresponding location.

As motion vectors and associated prediction errors are received they are stored in the motion vector buffer 24.

A timer triggers update of the display buffer Dbuf1 16 every Tf period and the next available motion vector and associated prediction errors are applied to it.

This process continues till all sub-frames of the second I-frame have been received in Ibuf0 20.

Contents of Ibuf0 20 are inverse-coded into Dbuf0 14 and motion vectors stored in the motion vector buffer 24 and their associated prediction errors are applied sequentially to I-frame stored in Ibuf0 20.

A copy of Dbuf0 14 is saved in the backup display buffer 26. Contents of the backup display buffer 26 when coded are used to substitute missing or corrupted sub-frames of the incoming I-frame.

After all motion vectors stored in the motion vector buffer 24 have been applied to the contents of Ibuf0 20 the following happens:

(a) Dbuf0 14 becomes the current display buffer

(b) Motion vector buffer 24 is flushed

(c) Sub-frames of the next I-frame are stored in Ibuf1 22.

This process keeps repeating itself.

(i) A method of compensation for lost or excessively delayed sub-frame packets at the destination so that the loss of a sub-frame does not affect the quality of picture frame adversely.

(ii) A method of cut-through transmission of motion vectors and associated error packets for frames that are not transmitted as I-farmes along with sub-frame packets of the I-frames that are transmitted.

(b) The method is scalable. Availability of greater bandwidth could improve:

(2) The ratio of I-frame/motion vector & error packets.

(3) The size of the I-frames.

(4) Frequency of audio frames.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What is claimed is:

1. A method of receiving video images from a source for real time two way communications over a transmission network, wherein said video images are transmitted via a plurality of time spaced I-frame picture frames, wherein each of said plurality of I-frame picture frames further includes a plurality of sub-frames, said method comprising:
receiving and storing each of said plurality of sub-frames of a first I-frame picture in a first I-frame buffer;
receiving at least one associated motion vector of said first I frame picture frame in a motion vector buffer, wherein said motion vector buffer further includes associated prediction errors;
updating a first display buffer sequenced predetermined time intervals using said at least one associated motion vector;
applying said at least one associated motion vector sequentially to said contents of said first I-frame buffer;
inversely coding the contents of said first I-frame buffer into a second display buffer;
flushing said at least one associated motion vector from said motion vector buffer;
copying the contents of said second display buffer to a backup display buffer;
receiving and storing each of said plurality of sub-frames of a second I-frame picture in the second I-frame buffer;
receiving at least one associated motion vector of said second I-frame picture frame in a motion vector buffer, wherein said motion vector buffer further includes associated prediction errors;
updating the second display buffer sequenced predetermined time intervals using said at least one associated motion vector;
applying said at least one associated motion vector of said second I-frame picture frame sequentially to said contents of said second I-frame buffer;
inversely coding the contents of said second I-frame buffer into the first buffer;
flushing said at least one associated motion vector of said second I-frame picture frame from said motion vector buffer; and
copying the contents of said first display buffer to a backup display buffer.

2. A method of transmission of video images from a source to a destination for real time two-way communication over IP, the method comprising:
Fragmenting I-frames in a way such that the transmission of an encoded/compressed sub-frame packet, a motion vector & associated error packet & an audio packet take less time than a pre-determined fixed interval required for real time audio communication;
Encoding each sub-frame at the source in such a way that the loss of a sub-frame packet does not impact the decompression and decode of the sub-frame at destination; and
Sequencing sub-frame packets at the source such that the original I-frame can be recovered at destination by combining the sub-frames.
